(19) United States
(12) Patent Application Publication
(10) Pub. No.: US 2018/0165760 A1
(43) Pub. Date: Jun. 14, 2018

(54) TRANSPARENT RESOURCE MATCHING

(71) Applicant: Alibaba Group Holding Limited, George Town (KY)

(72) Inventors: Lida Xie, Shanghai (CN); Qirui Li, Hangzhou (CN); Gang Lu, Hangzhou (CN)

(73) Assignee: Alibaba Group Holding Limited, George Town (KY)

(21) Appl. No.: 15/833,838

(22) Filed: Dec. 6, 2017

(30) Foreign Application Priority Data
Dec. 8, 2016 (CN) 201611121965.1

(51) Int. Cl. G06Q 40/02

(52) U.S. Cl. CPC G06Q 40/02

(57) ABSTRACT

Information associated with matching a resource between two or more first users is generated by a resource platform. The information is transmitted, by the resource platform, to at least one user of the two or more first users. One or more verification results associated with the information are received by the resource platform and from one or more second users. A determination is made, by the resource platform, that the information is verified by the one or more second users based on the received one or more verification results. In response to the determination, the resource is transferred between the two or more first users by the resource platform.

### CROSS REFERENCE TO RELATED APPLICATIONS

This application claims priority to Chinese Application No. 201611121965.1, filed on Dec. 8, 2016, which is incorporated by reference is its entirety.

### BACKGROUND

When a resource platform matches a resource requester and a resource provider, a resource matching and deployment process is not transparent to the resource requester and the resource provider, or both. In particular, the resource provider does not know whether the resource requester can be considered a qualified user, and may suffer a loss (for example, economic or privacy) if the resource requester is not a qualified user.

### SUMMARY

The present disclosure describes transparent resource matching.

In an implementation, information associated with matching a resource between two or more first users is generated by a resource platform. The information is transmitted, by the resource platform, to at least one user of the two or more first users. One or more verification results associated with the information are received by the resource platform and from one or more second users. A determination is made, by the resource platform, that the information is verified by the one or more second users based on the received one or more verification results. In response to the determination, the resource is transferred between the two or more first users by the resource platform.

Implementations of the described subject matter, including the previously described implementation, can be implemented using a computer-implemented method; a non-transitory, computer-readable medium storing computer-readable instructions to perform the computer-implemented method; and a computer-implemented system comprising one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The subject matter described in this specification can be implemented in particular implementations, so as to realize one or more of the following advantages. First, the described approach can be used to enable transparent resource matching. For example, when a resource platform (for example, a person-to-person (P2P) platform) matches a resource requester and a resource provider, the resource platform generates matching information and transmits the matching information to the resource requester, the resource provider, or both. The matching information is broadcasted, by the resource requester, the resource provider, or both, to one or more users of the resource platform. The one or more users verify the matching information and transmit one or more verification results to the resource platform. The resource platform determines whether the matching information is verified by the one or more users based on the one or more verification results. In response to determining that the matching information is verified, the resource platform performs the resource matching (for example, transfer a resource from the resource provider to the resource requester). In doing so, the resource matching and deployment process is not solely decided by the resource platform, rather the resource matching and deployment process needs approval from the one or more users of the resource platform. As a result, the resource matching and deployment process is transparent to the resource requester, the resource provider, or both. Second, the described approach can avoid a loss to the resource provider due to the matched resource requester being an unqualified user. Other advantages will be apparent to those of ordinary skill in the art.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIG. 1 is a block diagram illustrating an example of a networking environment for transparent resource matching, according to an implementation of the present disclosure.

FIG. 2 is a flowchart illustrating an example of a computer-implemented method for transparent resource matching, according to an implementation of the present disclosure.

FIG. 3 is a block diagram illustrating an example of a block chain for storing historical resource matching data, according to an implementation of the present disclosure.

FIGS. 4A and 4B are block diagrams illustrating other examples of block chains for storing historical resource matching data, according to an implementation of the present disclosure.

FIG. 5 is a block diagram illustrating an example of stored resource matching data in a block, according to an implementation of the present disclosure.

FIG. 6 is a flowchart illustrating another example of a computer-implemented method for transparent resource matching, according to an implementation of the present disclosure.

FIG. 7 is a block diagram illustrating an example of querying historical resource matching data, according to an implementation of the present disclosure.

FIG. 8 is a flowchart illustrating another example of a computer-implemented method for transparent resource matching, according to an implementation of the present disclosure.

FIG. 9 is a block diagram illustrating examples of data processing devices for transparent resource matching, according to an implementation of the present disclosure.

FIG. 10 is a block diagram illustrating an example of a computer-implemented system used to provide computational functionalities associated with described algorithms, methods, functions, processes, flows, and procedures, according to an implementation of the present disclosure.

Like reference numbers and designations in the various drawings indicate like elements.

### DETAILED DESCRIPTION

The following detailed description describes transparent resource matching, and is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined herein can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

When a resource platform matches a resource requester and a resource provider, a resource matching and deployment process is not transparent to the resource requester and the resource provider, or both. In particular, the resource provider does not know whether the resource requester can be considered a qualified user (such as, a legal user or a user with good credit record). If the resource requester is not a qualified user, the resource requester may default on a resource matching agreement between the resource requester and the resource provider. As a result, the resource provider may suffer a loss (for example, an amount of money lent to the resource requester or personally identifiable information) if the resource requester is not a qualified user.

At a high-level, the described approach provides a decentralized mechanism to verify information of a resource matching by one or more users of a resource platform, before the resource platform performs the resource matching. For example, when the resource platform matches a resource requester and a resource provider, the resource platform generates matching information (for example, information associated with the resource matching between the resource requester and the resource provider), and transmits the matching information to the resource requester, the resource provider, or both. The matching information is broadcast, by the resource requester, the resource provider, or both, to the one or more users of the resource platform. The one or more users verify the matching information (for example, based on historical resource matching data stored by the resource platform), and transmit one or more verification results to the resource platform. The resource platform determines whether the matching information is verified by the one or more users based on the one or more verification results. In response to determining that the matching information is verified, the resource platform performs the resource matching (for example, transferring a resource from the resource provider to the resource requester).

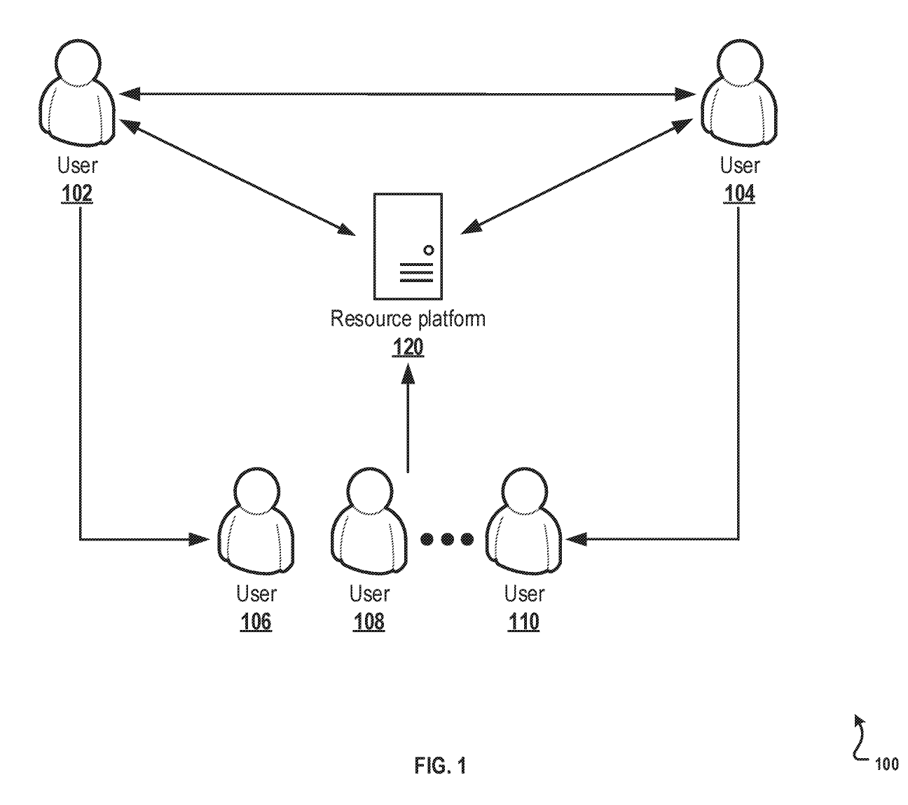

FIG. 1 is a block diagram illustrating an example of a networking environment 100 for transparent resource matching, according to an implementation of the present disclosure. For clarity of presentation, the description that follows generally describes environment 100 in the context of the other figures in this description.

As illustrated in FIG. 1, a resource platform 120 has many users, including users 102, 104, 106, 108, and 110. The resource platform 120 matches one or more users that request a resource with one or more users that can provide the resource. For example, user 102 can be a resource requester, user 104 can be a resource provider, and users 106, 108, and 110 can be users of the resource platform 120. User 102 requests a resource on the resource platform 120. User 104 provides a resource on the resource platform 120. The resource platform 120 matches user 102 with user 104 based on, for example, the resource requested by user 102, the resource provided by user 104, and a predetermined matching rule. Users 106, 108, and 110 verify information associated with the resource matching between user 102 and user 104.

In some implementations, the resource includes network storage resources, device processing resources (such as, CPU occupancy and memory occupancy), and financial resources (such as, money and line of credit). The resource platform 120 can be a resource platform server (or a cluster of servers) that provides services (such as, a resource matching service or a resource transferring service) to its users. The resource platform 120 can be a cloud storage platform, a finance platform, and a bank platform. The user of the resource platform 120 includes a person, an enterpriser, and a device used to access the resource platform 120.

In some implementations, the resource platform 120 matches resources between more than two users. For example, a single resource provider can be matched by the resource platform 120 to multiple resource requesters. A single resource requester can be matched by the resource platform 120 to multiple resource providers.

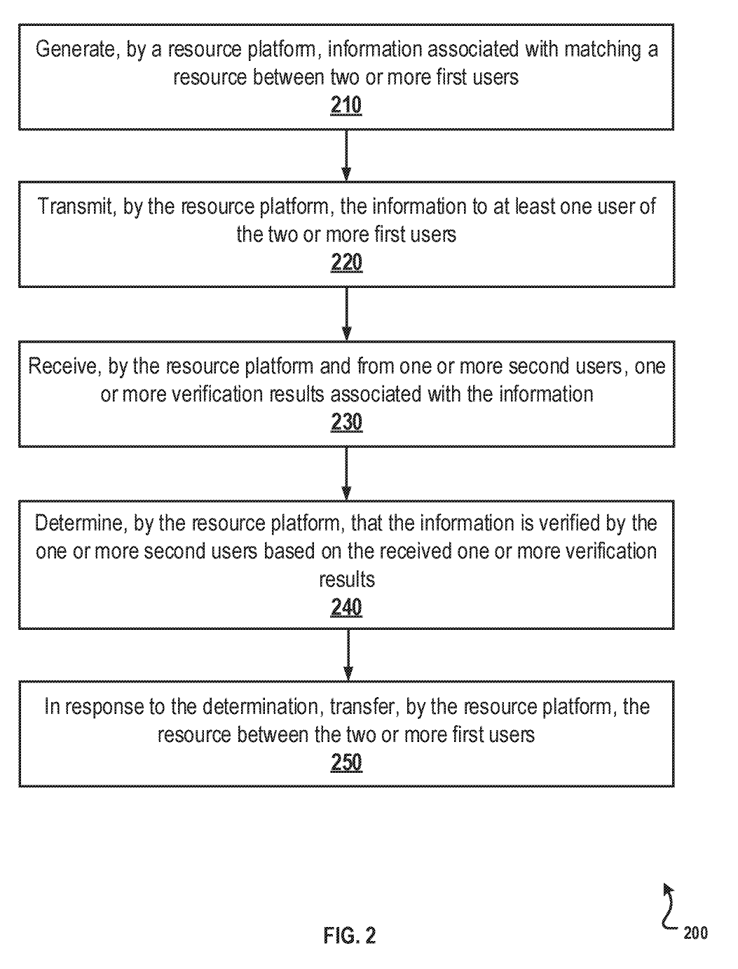

FIG. 2 is a flowchart illustrating an example of a computer-implemented method 200 for transparent resource matching, according to an implementation of the present disclosure. For clarity of presentation, the description that follows generally describes method 200 in the context of the other figures in this description. However, it will be understood that method 200 can be performed, for example, by any system, environment, software, and hardware, or a combination of systems, environments, software, and hardware, as appropriate. In some implementations, various steps of method 200 can be run in parallel, in combination, in loops, or in any order.

At 210, a resource platform generates information associated with matching a resource between two or more first users. The two or more first users include a user that requests the resource (that is, a resource requester) and a user that provides the resource (that is, a resource provider). The generated information includes user information of one or more users of the two or more first users. For example, the generated information includes user information of the resource requester, user information of the resource provider, or both. User information includes user identification information provided by a user when the user opens an account on the resource platform. In some implementations, user information includes a digital certificate provided by the resource platform. In some implementations, the generated information includes information of the resource (such as, type of the resource, amount of the resource). In some implementations, the generated information includes identification information (such as, a matching order number) that can uniquely identify the resource matching. The identification information can include a time stamp (for example, indicating a time when the resource matching process is performed), a serial number, or both.

The resource platform monitors resource matching processes performed on the resource platform in real time. In response to detecting a resource matching process, the resource platform generates information associated with the resource matching process. In a resource matching process, a resource requester is matched with a resource provider, and the resource is not transferred from the resource provider to the resource requester. In some implementations, the resource matching process is initiated by the two or more first users. For example, a resource provider initiates a resource matching process on the resource platform for a targeted resource requester. A resource requester can also initiate a resource matching process on the resource platform for a targeted resource provider. In some implementations, the resource matching process is initiated by the resource platform. For example, a resource requester requests a resource on the resource platform, and, in response to the request, the resource platform matches the resource requester with a suitable resource provider (for example, based on the requested resource and a matching rule provided by the suitable resource provider).

In some implementations, the resource platform is a financing platform (such as, a bank). The resource provider is an investor and the resource requester is an investee (or a financier). From 210, method 200 proceeds to 220.

At 220, the resource platform transmits the generated information to at least one user of the two or more first users. For example, the resource platform can transmit the generated information to the resource provider, so that the resource provider can verify the resource requester before transferring the resource to the resource requester. The resource platform can also transmit the generated information to the resource requester.

In some implementations, the at least one user of the two or more first users broadcasts the received generated information to one or more second users (for example, verification users). For example, the resource provider, the resource requester, or both, can broadcast the received generated information. The one or more second users are users of the resource platform. In some implementations, the one or more second users include all users of the resource platform. In some implementations, the one or more second users are users in a predetermined set of verification users.

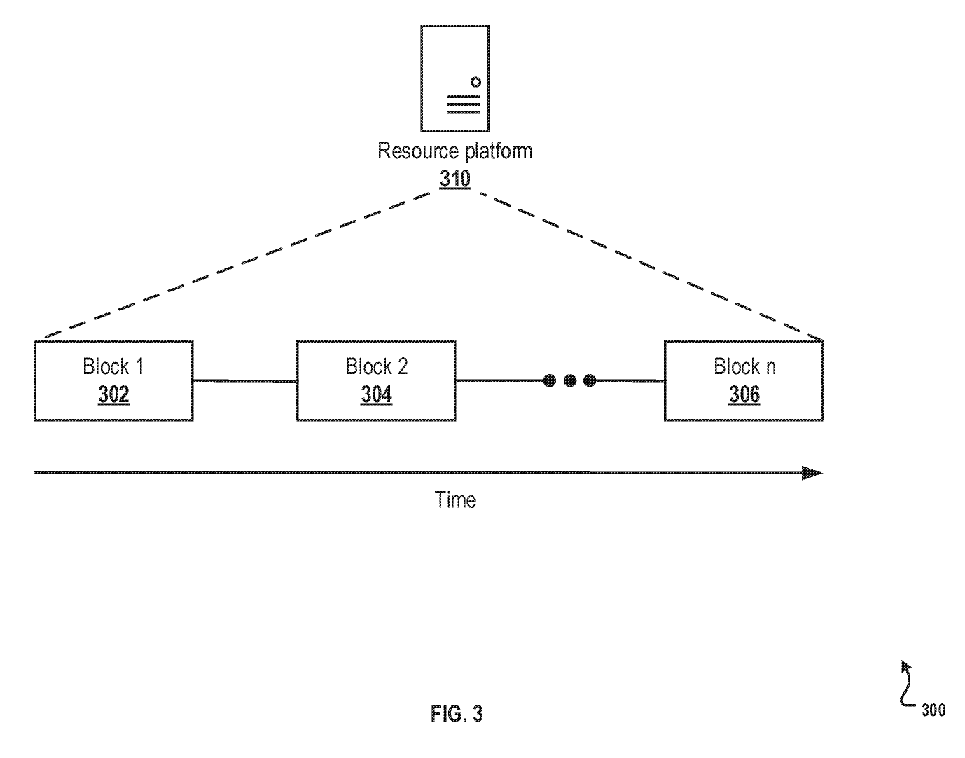

In some implementations, in response to receiving the broadcasted information, the one or more second users verify the information based on, for example, a historical resource matching data stored by the resource platform. For example, the resource platform can update the historical resource matching data to record information associated with a completed resource matching and transferring operation, where the historical resource matching data is stored in blocks of a block chain in a chronological order (discussed in more detail with respect to FIG. 3). In some implementations, the verification is to verify, within the broadcasted information, user identification information and the amount of matched resource, and generate a verification result. In some implementations, the one or more second users use a same verification standard. Verification performed by multiple users decentralizes the resource matching and deployment process (that is, not solely performed by the resource platform). From 220, method 200 proceeds to 230.

At 230, the resource platform receives, from the one or more second users, one or more verification results associated with the generated information. For example, the resource platform receives a corresponding verification result associated with the generated information from each user of the one or more second users. From 230, method 200 proceeds to 240.

At 240, the resource platform determines that the information is verified by the one or more second users based on the received one or more verification results. For example, if the one or more verification results indicate that the information is verified (that is, approved by the one or more second users), the resource platform can determine that it is safe to transfer the resource from the resource provider to the resource requester. In some implementations, the one or more verification results may not be the same. For example, some verification results can indicate that the information is verified, and others indicate that the information is not verified. The resource platform can determine that the information is verified if the number of results, indicating that the information is verified, exceeds a predetermined threshold (for example, 50%) of the total number of results. In some implementations, the resource platform can request a third-party verification center to verify the information (such as, verify credit of a resource requester, verify amount of resource owned by a resource provider). From 240, method 200 proceeds to 250.

At 250, in response to the determination, the resource platform transfers the resource between the two or more first users. For example, the resource is removed from an account associated with the resource provider, and deposited into an account associated with the resource requester.

In some implementations, after transferring the resource, the resource platform updates the historical resource matching data to include information of the resource transfer between the two or more first users. For example, the resource platform determines whether a last block (that is, a block storing the latest resource transferring information) in a block chain is available to store the information of the resource transfer between the two or more first users. If the last block is available, the resource platform stores the information of the resource transfer between the two or more first users in the last block. If the last block in not available, the resource platform creates a new block in the block chain, marks the new block as the last block, and stores the information of the resource transfer between the two or more first users in the new block (that is, the last block). The information of the resource transfer includes, for example, user identification information associated with the two or more first users, and amount of resource owned by the two or more first users after the resource transfer. After 250, method 200 stops.

FIG. 3 is a block diagram illustrating an example of a block chain 300 for storing historical resource matching data, according to an implementation of the present disclosure. For clarity of presentation, the description that follows generally describes block chain 300 in the context of the other figures in this description. As illustrated in FIG. 3, the block chain 300, maintained by a resource platform 310, includes Block1 302, Block2 304, and Blockn 306. In some implementations, the block chain 300 can include additional or different (or a combination of both) blocks not illustrated in the block diagram. In some implementations, blocks can also be omitted from the block chain 300.

As illustrated in FIG. 3, the resource platform 310 stores the historical resource matching data using a block chain technology to prevent stored data from modification. For example, the resource platform 310 stores the historical resource matching data in blocks (such as, Block1 302, Block2 304, Blockn 306) in the block chain 300. The blocks are created in a chronological order. Each block includes a time stamp indicating when the particular block is created. As illustrated in FIG. 3, Block1 302 is created before Block2 304, and Block2 304 is created before Blockn 306. In some implementations, each block includes identification information (such as, a hash value) of a previous block. The identification information of a particular block can uniquely identify the particular block. For example, Block2 304 includes identification information of Block1 302. Data stored in the blocks cannot be altered due to the block chain technology.

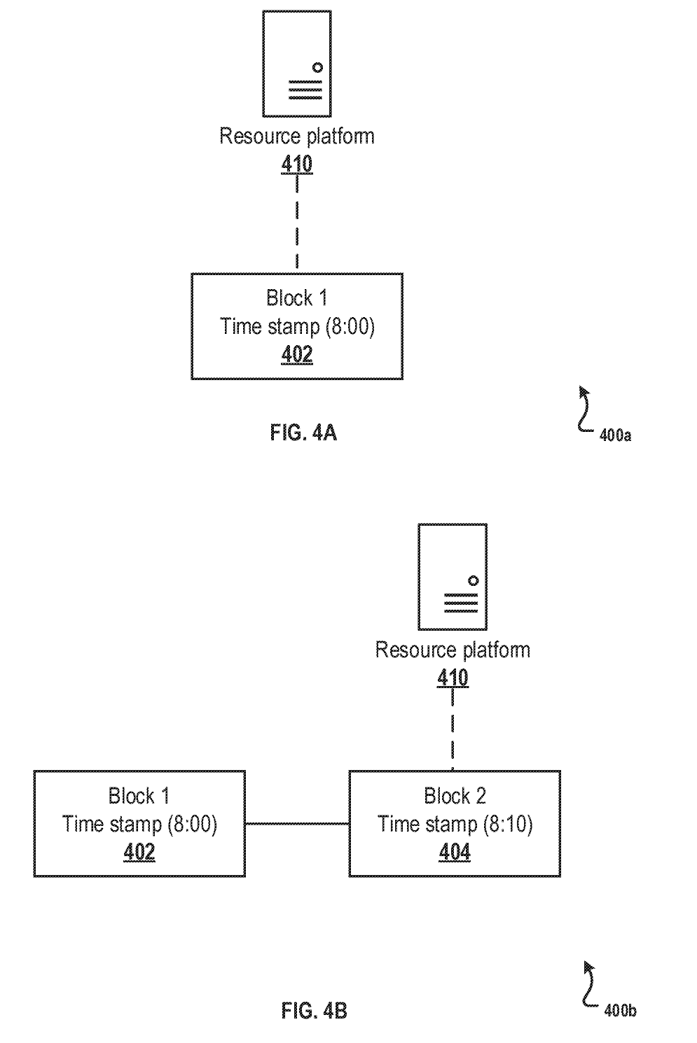

FIGS. 4A and 4B are block diagrams 400a and 400b, respectively, illustrating other examples of block chains for storing historical resource matching data, according to an implementation of the present disclosure. For clarity of presentation, the description that follows generally describes block chains 400a and 400b, maintained by resource platform 410, in the context of the other figures in this description. As illustrated in FIG. 4A, the block chain 400a includes Block1 402, and, in FIG. 4B, the block chain 400b includes Block1 402 and Block2 404. In some implementations, the block chains 400a and 400b can include additional or different (or a combination of both) blocks not shown in the block diagram. In some implementations, blocks can also be omitted from the block chains 400a and 400b.

When storing historical resource matching data, the resource platform 410 writes data into blocks of a block chain in a chronological order according to creation time of the data. For example, as illustrated in FIG. 4A, the resource platform 410 creates Block1 402 at 8:00. After the Block1 402 is created, if the resource platform 410 performs one or more resource matching and transferring operations, the resource platform 410 stores information associated with the one or more resource matching and transferring operations in the Block1 402. When the storage capacity of the Block1 402 is exhausted, the resource platform 410 will create a new block.

As illustrated in FIG. 4B, the resource platform 410 creates Block2 404 (that is, a new block) at 8:10. Resource matching information created after 8:10 is stored in the Block2 404, until the storage capacity of the Block2 404 is exhausted. By that time, another new block will be created, similarly to creating the Block2 404.

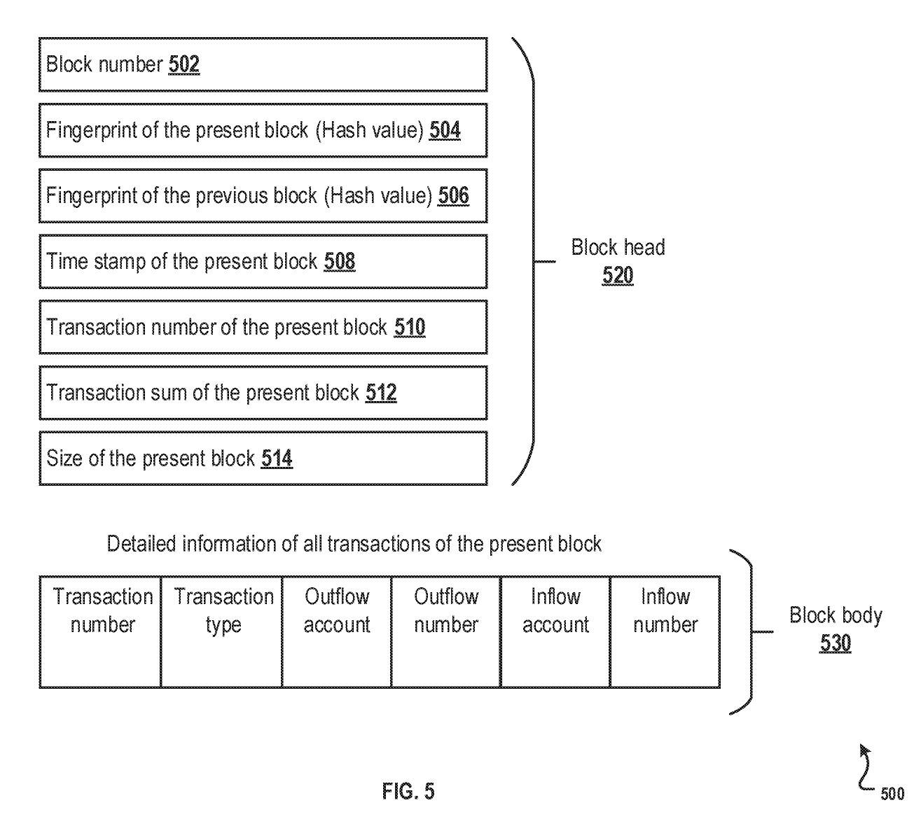

FIG. 5 is a block diagram illustrating an example of stored resource matching data in a block 500, according to an implementation of the present disclosure. For clarity of presentation, the description that follows generally describes data stored in the block 500 in the context of the other figures in this description. As illustrated in FIG. 5, the data stored in the block 500 includes a block head 520 and a block body 530. The block head 520 includes block number 502, fingerprint of the present block 504 (such as, a hash value of the present block), fingerprint of the previous block 506 (such as, a hash value of the previous block), time stamp of the present block 508, transaction number of the present block 510, transaction sum of the present block 512, and size of the present block 514. The block body 530 includes detailed information (such as, transaction number, transaction type, outflow account, outflow number, inflow account, and inflow number) of all transactions of the present block. In some implementations, the data stored in the block 500 can include additional or different (or a combination of both) components not shown in the block diagram. In some implementations, components can also be omitted from the data stored in the block 500.

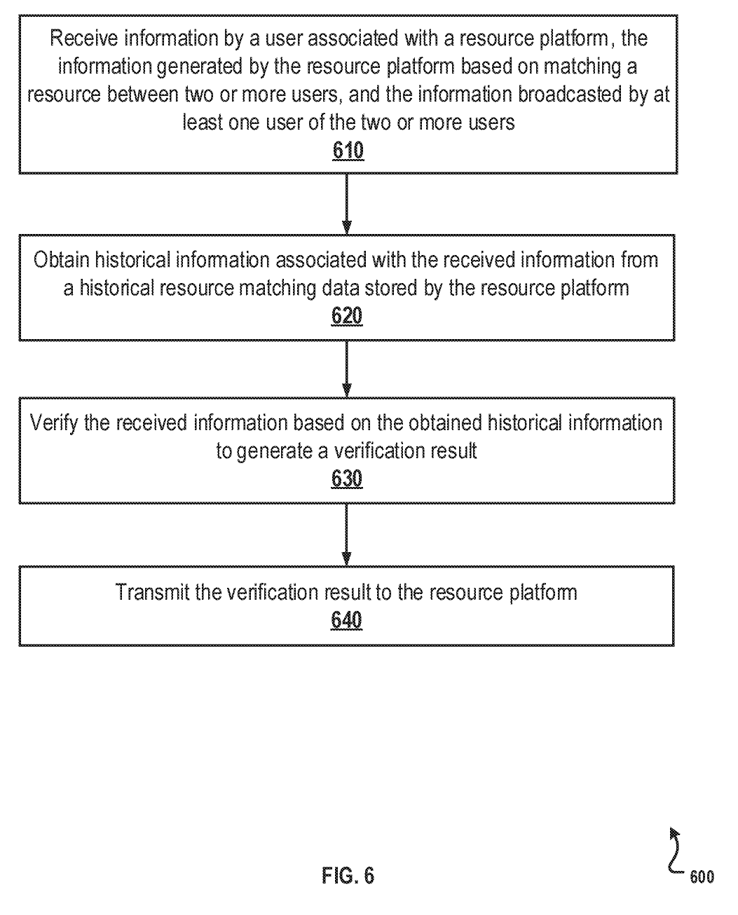

FIG. 6 is a flowchart illustrating another example of a computer-implemented method 600 for transparent resource matching, according to an implementation of the present disclosure. For clarity of presentation, the description that follows generally describes method 600 in the context of the other figures in this description. However, it will be understood that method 600 can be performed, for example, by any system, environment, software, and hardware, or a combination of systems, environments, software, and hardware, as appropriate. In some implementations, various steps of method 600 can be run in parallel, in combination, in loops, or in any order.

At 610, information is received by a user associated with a resource platform. The information is generated by the resource platform based on matching a resource between two or more users, and the information is broadcasted by at least one user of the two or more users. In some implementations, the information includes at least one of user information of the two or more users, information of the resource (such as, type of the resource or amount of the resource), or identification information (such as, a serial number) that can uniquely identify the resource matching. In some implementations, the user verifies the user information of the two or more users to determine whether the two or more users are legal users of the resource platform. From 610, method 600 proceeds to 620.

At 620, historical information associated with the received information is obtained from a historical resource matching data stored by the resource platform. For example, the user can identify user information of the two or more users from the received information. Based on the user information of the two or more users, the user can query the historical resource matching data to find historical information associated with the two or more users. From 620, method 600 proceeds to 630.

At 630, the user verifies the received information based on the obtained historical information to generate a verification result. In some implementations, the obtained historical information includes the amount of resources owned by the two or more users. The user can compare the amount of resource to be matched with the amount of resource owned by the two or more users. If the amount of resource to be matched is greater than the amount of resource owned by the two or more users, then a verification result indicating a failure is generated. From 630, method 600 proceeds to 640.

At 640, the verification result is transmitted to the resource platform. In some implementations, the resource platform receives one or more verification results from one or more users. The resource platform can determine whether or not to perform the resource transfer based on the one or more verification results. After 640, method 600 stops.

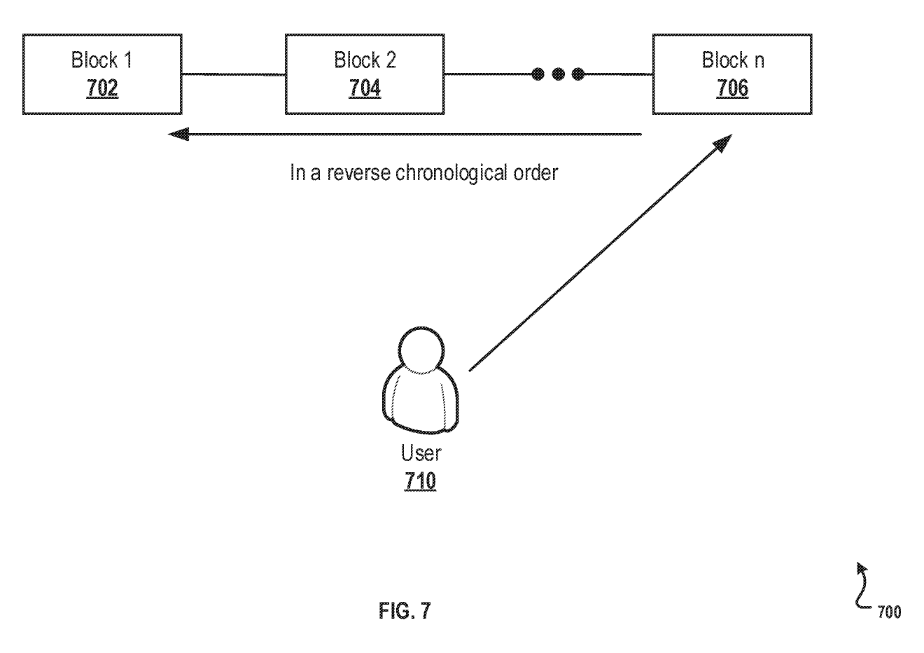

FIG. 7 is a block diagram 700 illustrating an example of querying historical resource matching data, according to an implementation of the present disclosure. For clarity of presentation, the description that follows generally describes diagram 700 in the context of the other figures in this description.

As illustrated in FIG. 7, the diagram 700 includes user 710 and a block chain with Block1 702, Block2 704, and Blockn 706. In some implementations, the diagram 700 can include additional or different (or a combination of both) blocks not shown in the block diagram. In some implementations, blocks may also be omitted from the diagram 700.

As illustrated in FIG. 7, the user 710 searches the block chain for historical information that matches information associated with a resource matching process. In the block chain, Blockn 706 is the most recently created block. The user 710 searches the Blockn 706 first, and searches other blocks of the block chain in a reverse chronological order. Once the user 710 finds the historical information in a particular block, the user 710 stops searching the block chain and starts verifying the information associated with the resource matching process based on the historical information.

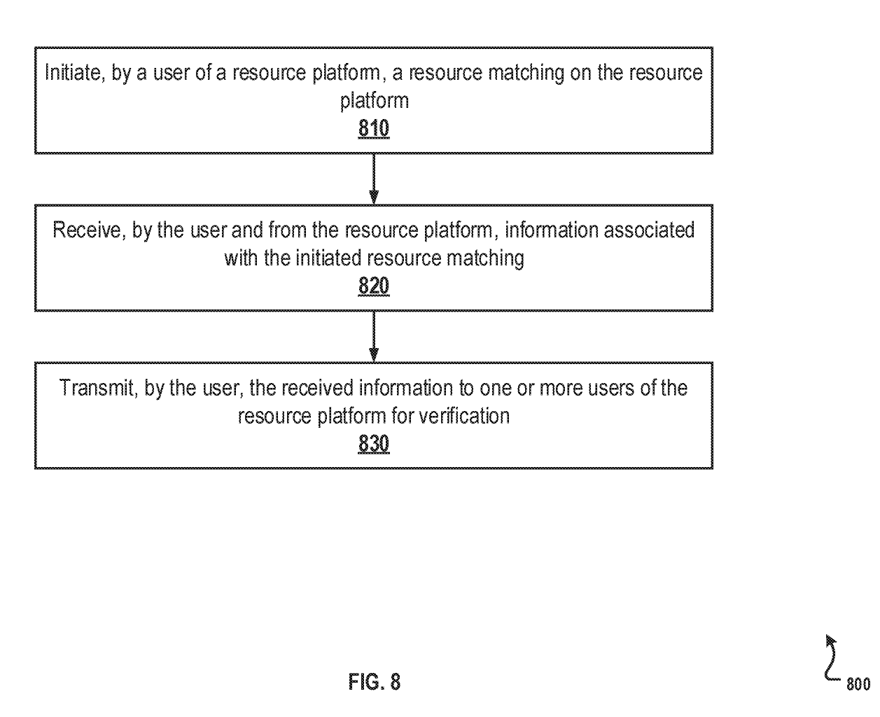

FIG. 8 is a flowchart illustrating another example of a computer-implemented method 800 for transparent resource matching, according to an implementation of the present disclosure. For clarity of presentation, the description that follows generally describes method 800 in the context of the other figures in this description. However, it will be understood that method 800 can be performed, for example, by any system, environment, software, and hardware, or a combination of systems, environments, software, and hardware, as appropriate. In some implementations, various steps of method 800 can be run in parallel, in combination, in loops, or in any order.

At 810, a user of a resource platform initiates a resource matching on the resource platform. The user can be a resource requester or a resource provider. For example, the user can issue a resource matching instruction that instructs the resource platform to complete a resource matching. The user can select another user who meets conditions defined by the user, and initiates a resource matching between the user and the another user. From 810, method 800 proceeds to 820.

At 820, the user receives, from the resource platform, information associated with the initiated resource matching. The information is generated by the resource platform once a resource matching operation is performed. The information includes user information associated with the resource matching. From 820, method 800 proceeds to 830.

At 830, the user transmits the received information to one or more users of the resource platform for verification. In some implementations, the user broadcasts the received information. After 830, method 800 stops.

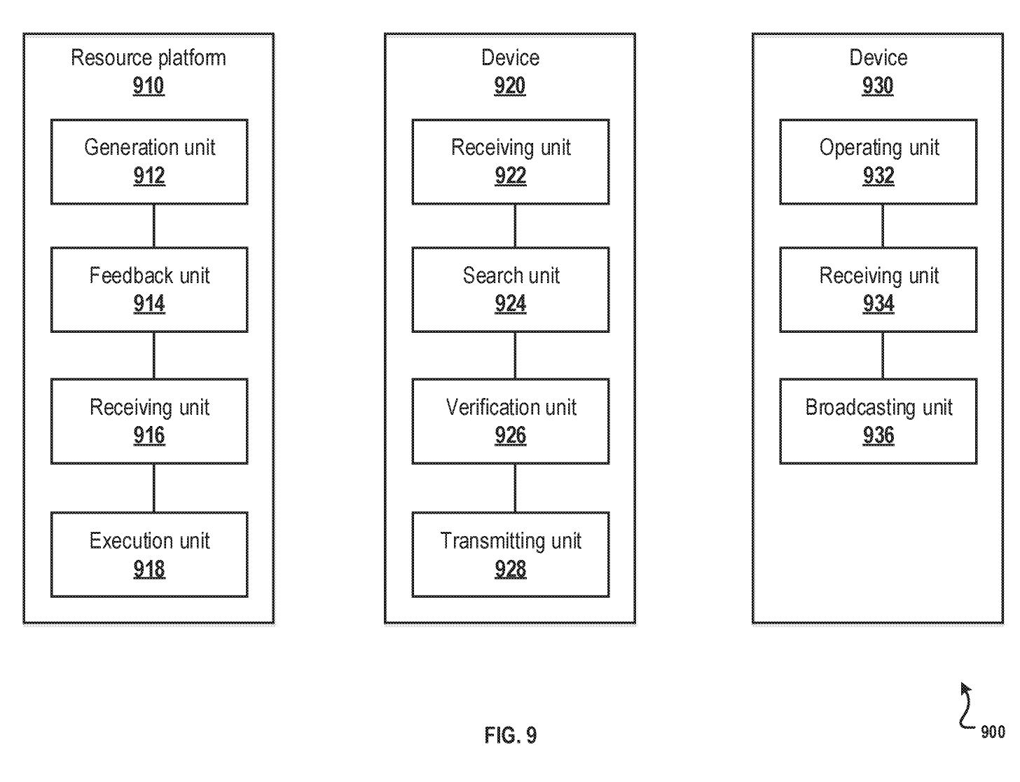

FIG. 9 is a block diagram illustrating examples of data processing devices 900 for transparent resource matching, according to an implementation of the present disclosure. For clarity of presentation, the description that follows generally describes devices 900 in the context of the other figures in this description. The devices 900 include a resource platform 910, a device 920, and a device 930.

The resource platform 910 can include a generation unit 912, a feedback unit 914, a receiving unit 916, and an execution unit 918, which can be implemented in hardware, software, or both. In some implementations, the resource platform 910 can include additional or different (or a combination of both) components not shown in the block diagram. In some implementations, components can also be omitted from the resource platform 910.

The generation unit 912 can generate resource matching information, as discussed in step 210 of FIG. 2. The feedback unit 914 can transmit resource matching information to one or more users associated with the resource matching, as discussed in step 220 of FIG. 2. The receiving unit 916 can receive verification results from verification users, as discussed in step 230 of FIG. 2. The execution unit 918 can transfer resource, as discussed in step 250 of FIG. 2.

The device 920 can include a receiving unit 922, a search unit 924, a verification unit 926, and a transmitting unit 928, which can be implemented in hardware, software, or both. In some implementations, the device 920 can include additional or different (or a combination of both) components not shown in the block diagram. In some implementations, components can also be omitted from the device 920.

The receiving unit 922 can receive information broadcasted by another user, as discussed in step 610 of FIG. 6. The search unit 924 can search a historical resource matching data, as discussed in step 620 of FIG. 6. The verification unit 926 can verify information, as discussed in step 630 of FIG. 6. The transmitting unit 928 can transmit verification result, as discussed in step 640 of FIG. 6.

The device 930 can include an operating unit 932, a receiving unit 934, and a broadcasting unit 936, which can be implemented in hardware, software, or both. In some implementations, the device 930 can include additional or different (or a combination of both) components not shown in the block diagram. In some implementations, components can also be omitted from the device 930.

The operating unit 932 can initiate a resource matching, as discussed in step 810 of FIG. 8. The receiving unit 934 can receive information from a resource platform, as discussed in step 820 of FIG. 8. The broadcasting unit 936 can broadcast information, as discussed in step 830 of FIG. 8.

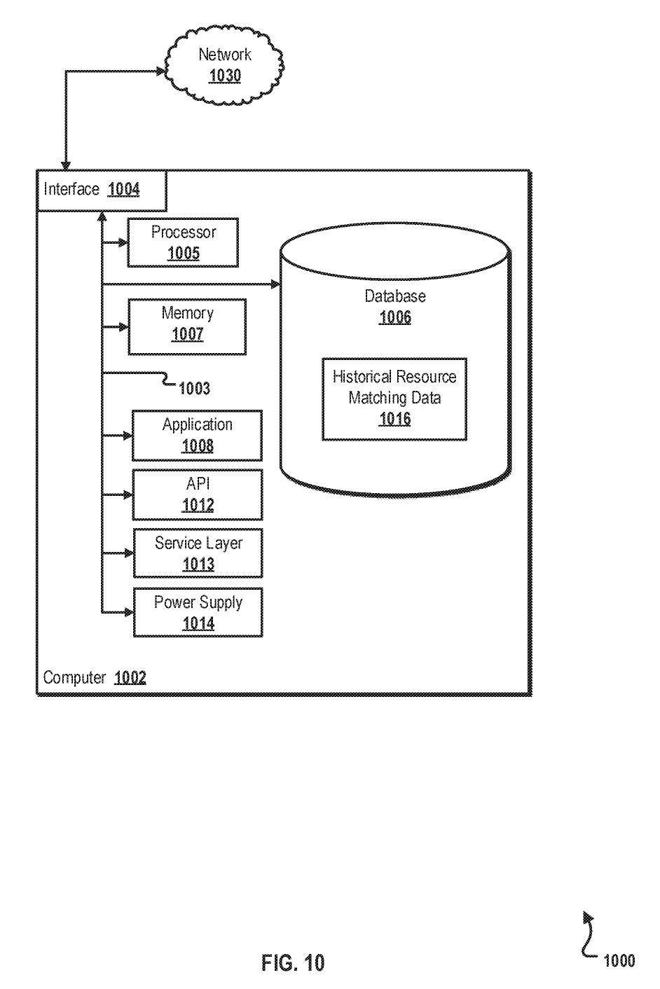

FIG. 10 is a block diagram illustrating an example of a computer-implemented System 1000 used to provide computational functionalities associated with described algorithms, methods, functions, processes, flows, and procedures, according to an implementation of the present disclosure. In the illustrated implementation, System 1000 includes a Computer 1002 and a Network 1030.

The illustrated Computer 1002 is intended to encompass any computing device such as a server, desktop computer, laptop/notebook computer, wireless data port, smart phone, personal data assistant (PDA), tablet computer, one or more processors within these devices, another computing device, or a combination of computing devices, including physical or virtual instances of the computing device, or a combination of physical or virtual instances of the computing device. Additionally, the Computer 1002 can include an input device, such as a keypad, keyboard, touch screen, another input device, or a combination of input devices that can accept user information, and an output device that conveys information associated with the operation of the Computer 1002, including digital data, visual, audio, another type of information, or a combination of types of information, on a graphical-type user interface (UI) (or GUI) or other UI.

The Computer 1002 can serve in a role in a distributed computing system as a client, network component, a server, a database or another persistency, another role, or a combination of roles for performing the subject matter described in the present disclosure. The illustrated Computer 1002 is communicably coupled with a Network 1030. In some implementations, one or more components of the Computer 1002 can be configured to operate within an environment, including cloud-computing-based, local, global, another environment, or a combination of environments.

At a high level, the Computer 1002 is an electronic computing device operable to receive, transmit, process, store, or manage data and information associated with the described subject matter. According to some implementations, the Computer 1002 can also include or be communicably coupled with a server, including an application server, e-mail server, web server, caching server, streaming data server, another server, or a combination of servers.

The Computer 1002 can receive requests over Network 1030 (for example, from a client software application executing on another Computer 1002) and respond to the received requests by processing the received requests using a software application or a combination of software applications. In addition, requests can also be sent to the Computer 1002 from internal users (for example, from a command console or by another internal access method), external or third-parties, or other entities, individuals, systems, or computers.

Each of the components of the Computer 1002 can communicate using a System Bus 1003. In some implementations, any or all of the components of the Computer 1002, including hardware, software, or a combination of hardware and software, can interface over the System Bus 1003 using an application programming interface (API) 1012, a Service Layer 1013, or a combination of the API 1012 and Service Layer 1013. The API 1012 can include specifications for routines, data structures, and object classes. The API 1012 can be either computer-language independent or dependent and refer to a complete interface, a single function, or even a set of APIs. The Service Layer 1013 provides software services to the Computer 1002 or other components (whether illustrated or not) that are communicably coupled to the Computer 1002. The functionality of the Computer 1002 can be accessible for all service consumers using the Service Layer 1013. Software services, such as those provided by the Service Layer 1013, provide reusable, defined functionalities through a defined interface. For example, the interface can be software written in JAVA, C++, another computing language, or a combination of computing languages providing data in extensible markup language (XML) format, another format, or a combination of formats. While illustrated as an integrated component of the Computer 1002, alternative implementations can illustrate the API 1012 or the Service Layer 1013 as stand-alone components in relation to other components of the Computer 1002 or other components (whether illustrated or not) that are communicably coupled to the Computer 1002. Moreover, any or all parts of the API 1012 or the Service Layer 1013 can be implemented as a child or a sub-module of another software module, enterprise application, or hardware module without departing from the scope of the present disclosure.

The Computer 1002 includes an Interface 1004. Although illustrated as a single Interface 1004, two or more Interfaces 1004 can be used according to particular needs, desires, or particular implementations of the Computer 1002. The Interface 1004 is used by the Computer 1002 for communicating with another computing system (whether illustrated or not) that is communicatively linked to the Network 1030 in a distributed environment. Generally, the Interface 1004 is operable to communicate with the Network 1030 and includes logic encoded in software, hardware, or a combination of software and hardware. More specifically, the Interface 1004 can include software supporting one or more communication protocols associated with communications such that the Network 1030 or hardware of Interface 1004 is operable to communicate physical signals within and outside of the illustrated Computer 1002.

The Computer 1002 includes a Processor 1005. Although illustrated as a single Processor 1005, two or more Processors 1005 can be used according to particular needs, desires, or particular implementations of the Computer 1002. Generally, the Processor 1005 executes instructions and manipulates data to perform the operations of the Computer 1002 and any algorithms, methods, functions, processes, flows, and procedures as described in the present disclosure.

The Computer 1002 also includes a Database 1006 that can hold data for the Computer 1002, another component communicatively linked to the Network 1030 (whether illustrated or not), or a combination of the Computer 1002 and another component. For example, Database 1006 can be an in-memory, conventional, or another type of database storing data consistent with the present disclosure. In some implementations, Database 1006 can be a combination of two or more different database types (for example, a hybrid in-memory and conventional database) according to particular needs, desires, or particular implementations of the Computer 1002 and the described functionality. Although illustrated as a single Database 1006, two or more databases of similar or differing types can be used according to particular needs, desires, or particular implementations of the Computer 1002 and the described functionality. While Database 1006 is illustrated as an integral component of the Computer 1002, in alternative implementations, Database 1006 can be external to the Computer 1002. As illustrated, the Database 1006 holds the previously described Historical Resource Matching Data 1016.

The Computer 1002 also includes a Memory 1007 that can hold data for the Computer 1002, another component or components communicatively linked to the Network 1030 (whether illustrated or not), or a combination of the Computer 1002 and another component. Memory 1007 can store any data consistent with the present disclosure. In some implementations, Memory 1007 can be a combination of two or more different types of memory (for example, a combination of semiconductor and magnetic storage) according to particular needs, desires, or particular implementations of the Computer 1002 and the described functionality. Although illustrated as a single Memory 1007, two or more Memories 1007 or similar or differing types can be used according to particular needs, desires, or particular implementations of the Computer 1002 and the described functionality. While Memory 1007 is illustrated as an integral component of the Computer 1002, in alternative implementations, Memory 1007 can be external to the Computer 1002.

The Application 1008 is an algorithmic software engine providing functionality according to particular needs, desires, or particular implementations of the Computer 1002, particularly with respect to functionality described in the present disclosure. For example, Application 1008 can serve as one or more components, modules, or applications. Further, although illustrated as a single Application 1008, the Application 1008 can be implemented as multiple Applications 1008 on the Computer 1002. In addition, although illustrated as integral to the Computer 1002, in alternative implementations, the Application 1008 can be external to the Computer 1002.

The Computer 1002 can also include a Power Supply 1014. The Power Supply 1014 can include a rechargeable or non-rechargeable battery that can be configured to be either user- or non-user-replaceable. In some implementations, the Power Supply 1014 can include power-conversion or management circuits (including recharging, standby, or another power management functionality). In some implementations, the Power Supply 1014 can include a power plug to allow the Computer 1002 to be plugged into a wall socket or another power source to, for example, power the Computer 1002 or recharge a rechargeable battery.

There can be any number of Computers 1002 associated with, or external to, a computer system containing Computer 1002, each Computer 1002 communicating over Network 1030. Further, the term “client,” “user,” or other appropriate terminology can be used interchangeably, as appropriate, without departing from the scope of the present disclosure. Moreover, the present disclosure contemplates that many users can use one Computer 1002, or that one user can use multiple computers 1002.

Described implementations of the subject matter can include one or more features, alone or in combination.

For example, in a first implementation, a computer-implemented method, comprising: generating, by a resource platform, information associated with matching a resource between two or more first users; transmitting, by the resource platform, the information to at least one user of the two or more first users; receiving, by the resource platform and from one or more second users, one or more verification results associated with the information; determining, by the resource platform, that the information is verified by the one or more second users based on the received one or more verification results; and in response to the determination, transferring, by the resource platform, the resource between the two or more first users.

The foregoing and other described implementations can each, optionally, include one or more of the following features:

A first feature, combinable with any of the following features, further comprising broadcasting, by the at least one user of the two or more first users, the information to the one or more second users.

A second feature, combinable with any of the previous or following features, wherein the information includes user information of one or more users of the two or more first users, and the two or more first users include a user that requests the resource and a user that provides the resource.

A third feature, combinable with any of the previous or following features, further comprising verifying, by the one or more second users, the user information based on a historical resource matching data, wherein the historical resource matching data is updated by the resource platform, and the historical resource matching data is stored in blocks of a block chain in a chronological order.

A fourth feature, combinable with any of the previous or following features, further comprising updating, by the resource platform, the historical resource matching data to include information of the resource transfer between the two or more first users.

A fifth feature, combinable with any of the previous or following features, wherein updating the historical resource matching data comprises: determining whether a last block in the block chain is available to store the information of the resource transfer between the two or more first users; in response to determining that the last block is available, storing the information of the resource transfer between the two or more first users in the last block; and in response to determining that the last block in not available: creating a new block in the block chain, wherein the new block becomes the last block in the block chain; and storing the information of the resource transfer between the two or more first users in the new block.

A sixth feature, combinable with any of the previous or following features, wherein the resource platform is a financing platform, and the resource is an amount of money.

In a second implementation, a non-transitory, computer-readable medium storing one or more instructions executable by a computer system to perform operations comprising: generating, by a resource platform, information associated with matching a resource between two or more first users; transmitting, by the resource platform, the information to at least one user of the two or more first users; receiving, by the resource platform and from one or more second users, one or more verification results associated with the information; determining, by the resource platform, that the information is verified by the one or more second users based on the received one or more verification results; and in response to the determination, transferring, by the resource platform, the resource between the two or more first users.

The foregoing and other described implementations can each, optionally, include one or more of the following features:

A first feature, combinable with any of the following features, the operations further comprising broadcasting, by the at least one user of the two or more first users, the information to the one or more second users.

A second feature, combinable with any of the previous or following features, wherein the information includes user information of one or more users of the two or more first users, and the two or more first users include a user that requests the resource and a user that provides the resource.

A third feature, combinable with any of the previous or following features, the operations further comprising verifying, by the one or more second users, the user information based on a historical resource matching data, wherein the historical resource matching data is updated by the resource platform, and the historical resource matching data is stored in blocks of a block chain in a chronological order.

A fourth feature, combinable with any of the previous or following features, the operations further comprising updating, by the resource platform, the historical resource matching data to include information of the resource transfer between the two or more first users.

A fifth feature, combinable with any of the previous or following features, wherein updating the historical resource matching data comprises: determining whether a last block in the block chain is available to store the information of the resource transfer between the two or more first users; in response to determining that the last block is available, storing the information of the resource transfer between the two or more first users in the last block; and in response to determining that the last block in not available: creating a new block in the block chain, wherein the new block becomes the last block in the block chain; and storing the information of the resource transfer between the two or more first users in the new block.

A sixth feature, combinable with any of the previous or following features, wherein the resource platform is a financing platform, and the resource is an amount of money.

In a third implementation, a computer-implemented system, comprising: one or more computers; and one or more computer memory devices interoperably coupled with the one or more computers and having tangible, non-transitory, machine-readable media storing instructions that, when executed by the one or more computers, perform operations comprising: generating, by a resource platform, information associated with matching a resource between two or more first users; transmitting, by the resource platform, the information to at least one user of the two or more first users; receiving, by the resource platform and from one or more second users, one or more verification results associated with the information; determining, by the resource platform, that the information is verified by the one or more second users based on the received one or more verification results; and in response to the determination, transferring, by the resource platform, the resource between the two or more first users.

The foregoing and other described implementations can each, optionally, include one or more of the following features:

A first feature, combinable with any of the following features, the operations further comprising broadcasting, by the at least one user of the two or more first users, the information to the one or more second users.

A second feature, combinable with any of the previous or following features, wherein the information includes user information of one or more users of the two or more first users, and the two or more first users include a user that requests the resource and a user that provides the resource.

A third feature, combinable with any of the previous or following features, the operations further comprising verifying, by the one or more second users, the user information based on a historical resource matching data, wherein the historical resource matching data is updated by the resource platform, and the historical resource matching data is stored in blocks of a block chain in a chronological order.

A fourth feature, combinable with any of the previous or following features, the operations further comprising updating, by the resource platform, the historical resource matching data to include information of the resource transfer between the two or more first users.

A fifth feature, combinable with any of the previous or following features, wherein updating the historical resource matching data comprises: determining whether a last block in the block chain is available to store the information of the resource transfer between the two or more first users; in response to determining that the last block is available, storing the information of the resource transfer between the two or more first users in the last block; and in response to determining that the last block in not available: creating a new block in the block chain, wherein the new block becomes the last block in the block chain; and storing the information of the resource transfer between the two or more first users in the new block.

A sixth feature, combinable with any of the previous or following features, wherein the resource platform is a financing platform, and the resource is an amount of money.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second (s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” or “electronic computer device” (or an equivalent term as understood by one of ordinary skill in the art) refer to data processing hardware and encompass all kinds of apparatus, devices, and machines for processing data, including by way of example, a programmable processor, a computer, or multiple processors or computers. The computer can also be, or further include special purpose logic circuitry, for example, a central processing unit (CPU), an FPGA (field programmable gate array), or an ASIC (application-specific integrated circuit). In some implementations, the computer or computer-implemented system or special purpose logic circuitry (or a combination of the computer or computer-implemented system and special purpose logic circuitry) can be hardware- or software-based (or a combination of both hardware- and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system of some type, for example LINUX, UNIX, WINDOWS, MAC OS, ANDROID, IOS, another operating system, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special purpose logic circuitry, for example, a CPU, an FPGA, or an ASIC.

Computers for the execution of a computer program can be based on general or special purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/−R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special purpose logic circuitry.

To provide for interaction with a user, implementations of the subject matter described in this specification can be implemented on a computer having a display device, for example, a CRT (cathode ray tube), LCD (liquid crystal display), LED (Light Emitting Diode), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity, a multi-touch screen using capacitive or electric sensing, or another type of touchscreen. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface,” or “GUI,” can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n or 802.20 (or a combination of 802.11x and 802.20 or other protocols consistent with the present disclosure), all or a portion of the Internet, another communication network, or a combination of communication networks. The communication network can communicate with, for example, Internet Protocol (IP) packets, Frame Relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or on the scope of what can be claimed, but rather as descriptions of features that can be specific to particular implementations of particular inventions. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method, comprising:
generating, by a resource platform, information associated with matching a resource between two or more first users;
transmitting, by the resource platform, the information to at least one user of the two or more first users;
receiving, by the resource platform and from one or more second users, one or more verification results associated with the information;
determining, by the resource platform, that the information is verified by the one or more second users based on the received one or more verification results; and
in response to the determination, transferring, by the resource platform, the resource between the two or more first users.

2. The computer-implemented method of claim 1, further comprising broadcasting, by the at least one user of the two or more first users, the information to the one or more second users.

3. The computer-implemented method of claim 1, wherein the information includes user information of one or more users of the two or more first users, and the two or more first users include a user that requests the resource and a user that provides the resource.

4. The computer-implemented method of claim 3, further comprising verifying, by the one or more second users, the user information based on a historical resource matching data, wherein the historical resource matching data is updated by the resource platform, and the historical resource matching data is stored in blocks of a block chain in a chronological order.

5. The computer-implemented method of claim 4, further comprising updating, by the resource platform, the historical resource matching data to include information of the resource transfer between the two or more first users.

6. The computer-implemented method of claim 5, wherein updating the historical resource matching data comprises:
determining whether a last block in the block chain is available to store the information of the resource transfer between the two or more first users;
in response to determining that the last block is available, storing the information of the resource transfer between the two or more first users in the last block; and
in response to determining that the last block in not available:
creating a new block in the block chain, wherein the new block becomes the last block in the block chain; and
storing the information of the resource transfer between the two or more first users in the new block.

7. The computer-implemented method of claim 1, wherein the resource platform is a financing platform, and the resource is an amount of money.

8. A non-transitory, computer-readable medium storing one or more instructions executable by a computer system to perform operations comprising:
generating, by a resource platform, information associated with matching a resource between two or more first users;
transmitting, by the resource platform, the information to at least one user of the two or more first users;
receiving, by the resource platform and from one or more second users, one or more verification results associated with the information;
determining, by the resource platform, that the information is verified by the one or more second users based on the received one or more verification results; and
in response to the determination, transferring, by the resource platform, the resource between the two or more first users.

9. The non-transitory, computer-readable medium of claim 8, the operations further comprising broadcasting, by the at least one user of the two or more first users, the information to the one or more second users.

10. The non-transitory, computer-readable medium of claim 8, wherein the information includes user information of one or more users of the two or more first users, and the two or more first users include a user that requests the resource and a user that provides the resource.

11. The non-transitory, computer-readable medium of claim 10, the operations further comprising verifying, by the one or more second users, the user information based on a historical resource matching data, wherein the historical resource matching data is updated by the resource platform, and the historical resource matching data is stored in blocks of a block chain in a chronological order.

12. The non-transitory, computer-readable medium of claim 11, the operations further comprising updating, by the resource platform, the historical resource matching data to include information of the resource transfer between the two or more first users.

13. The non-transitory, computer-readable medium of claim 12, wherein updating the historical resource matching data comprises:
determining whether a last block in the block chain is available to store the information of the resource transfer between the two or more first users;
in response to determining that the last block is available, storing the information of the resource transfer between the two or more first users in the last block; and
in response to determining that the last block in not available:
creating a new block in the block chain, wherein the new block becomes the last block in the block chain; and
storing the information of the resource transfer between the two or more first users in the new block.

14. The non-transitory, computer-readable medium of claim 8, wherein the resource platform is a financing platform, and the resource is an amount of money.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
generating, by a resource platform, information associated with matching a resource between two or more first users;
transmitting, by the resource platform, the information to at least one user of the two or more first users;
receiving, by the resource platform and from one or more second users, one or more verification results associated with the information;
determining, by the resource platform, that the information is verified by the one or more second users based on the received one or more verification results; and
in response to the determination, transferring, by the resource platform, the resource between the two or more first users.

16. The computer-implemented system of claim 15, the operations further comprising broadcasting, by the at least one user of the two or more first users, the information to the one or more second users.

17. The computer-implemented system of claim 15, wherein the information includes user information of one or more users of the two or more first users, and the two or more first users include a user that requests the resource and a user that provides the resource.

18. The computer-implemented system of claim 17, the operations further comprising verifying, by the one or more second users, the user information based on a historical resource matching data, wherein the historical resource matching data is updated by the resource platform, and the historical resource matching data is stored in blocks of a block chain in a chronological order.

19. The computer-implemented system of claim 18, the operations further comprising updating, by the resource platform, the historical resource matching data to include information of the resource transfer between the two or more first users.

20. The computer-implemented system of claim 19, wherein updating the historical resource matching data comprises:
determining whether a last block in the block chain is available to store the information of the resource transfer between the two or more first users;
in response to determining that the last block is available, storing the information of the resource transfer between the two or more first users in the last block; and
in response to determining that the last block in not available:
creating a new block in the block chain, wherein the new block becomes the last block in the block chain; and
storing the information of the resource transfer between the two or more first users in the new block.
